(19) United States
(12) Patent Application Publication
(10) Pub. No.: US 2020/0235633 A1
(43) Pub. Date: Jul. 23, 2020

(54) ACTUATOR

(71) Applicant: DENSO CORPORATION, Kariya-city (JP)

(72) Inventors: Atsushi TANAKA, Kariya-city (JP); Naoaki KONO, Kariya-city (JP); Tetsuji YAMANAKA, Kariya-city (JP); Kunio NAMBA, Kariya-city (JP)

(21) Appl. No.: 16/840,861

(22) Filed: Apr. 6, 2020

Related U.S. Application Data
(63) Continuation of application No. PCT/JP2018/038671, filed on Oct. 17, 2018.

(30) Foreign Application Priority Data
Oct. 20, 2017 (JP) 2017-203301

(51) Int. Cl. H02K 5/22; F02B 37/18; H02K 5/10; H02K 7/08; H02K 7/116; H02K 11/215

(52) U.S. Cl. CPC H02K 5/225; F02B 37/186; H02K 11/215; H02K 7/08; H02K 7/116; H02K 5/10

(57) ABSTRACT

An actuator drives a boost pressure control valve of a supercharger and includes an electric motor, an output shaft, a speed reducer, a rotational angle sensor, a housing and a wiring holder member. The wiring holder member is formed separately from the housing and integrally holds: a sensing device of the rotational angle sensor; and an electric wiring of the electric motor and of the sensing device. A second housing segment of the housing includes a connector insertion hole that extends through the second housing segment from an inside to an outside of the housing. The wiring holder member forms a connector that receives an end portion of the electric wiring and projects from the inside to the outside of the housing through the connector insertion hole.

### CROSS REFERENCE TO RELATED APPLICATIONS

This application is a continuation application of International Patent Application No. PCT/JP2018/038671 filed on Oct. 17, 2018, which designated the U.S. and claims the benefit of priority from Japanese Patent Application No. 2017-203301 filed on Oct. 20, 2017. The entire disclosures of all of the above applications are incorporated herein by reference.

### TECHNICAL FIELD

The present disclosure relates to an actuator that drives a boost pressure control valve of a supercharger.

### BACKGROUND

Previously, there is known an actuator that is connected to the boost pressure control valve through, for example, a linkage mechanism and controls a boost pressure by adjusting a valve opening degree of the boost pressure control valve.

### SUMMARY

This section provides a general summary of the disclosure, and is not a comprehensive disclosure of its full scope or all of its features.

According to the present disclosure, there is provided an actuator configured to drive a boost pressure control valve of a supercharger. The actuator includes an electric motor, an output shaft, a speed reducer, a rotational angle sensor and a housing. The speed reducer is configured to reduce a speed of rotation outputted from the electric motor and transmit the rotation of the reduced speed to the output shaft. The rotational angle sensor is configured to sense a rotational angle of the output shaft. The housing receives the electric motor and the speed reducer and supports the output shaft.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram showing an intake and exhaust system of an internal combustion engine, at which an actuator according to a first embodiment is applied.

FIG. 2 is a descriptive diagram of a supercharger.

FIG. 3 is a perspective view of the actuator.

FIG. 4 is a top view of the actuator.

FIG. 5 is a cross-sectional view taken along line V-V in FIG. 4.

FIG. 6 is a cross-sectional view taken along line VI-VI in FIG. 4.

FIG. 7 is a diagram showing a state where a second housing segment of the actuator of FIG. 4 is removed.

FIG. 8 is a diagram indicating the second housing segment, a wiring holder member and other components seen from an inside of the second housing segment.

FIG. 9 is a cross-sectional view taken along line IX-IX in FIG. 8.

FIG. 10 is a cross-sectional view taken along line X-X in FIG. 9.

FIG. 11 is a cross-sectional view taken along line XI-XI in FIG. 9.

FIG. 12 is a diagram showing a state in the middle of assembling the second housing segment and the wiring holder member together.

FIG. 13 is a diagram corresponding to FIG. 8 and is for describing two imaginary straight lines.

FIG. 14 is a cross-sectional view taken along line XIV-XIV in FIG. 8.

FIG. 15 is a diagram illustrating a state in which a fitting portion limits rotation of the wiring holder member about a positioning projection.

FIG. 16 is a diagram illustrating a state in which a fitting portion limits rotation of a wiring holder member about a positioning projection in a comparative example.

FIG. 17 is a cross-sectional view a connector and a connector insertion hole of an actuator according to a second embodiment.

FIG. 18 is a diagram indicating a second housing segment, a wiring holder member and other components of an actuator seen from an inside of the second housing segment according to a third embodiment.

FIG. 19 is a cross-sectional view taken along line XIX-XIX n FIG. 18.

### DETAILED DESCRIPTION

Previously, there is known an actuator that is connected to the boost pressure control valve through, for example, a linkage mechanism and controls a boost pressure by adjusting a valve opening degree of the boost pressure control valve. One such actuator reduces a speed of rotation outputted from an electric motor through a speed reducer and thereafter outputs the rotation through an output shaft. A rotational angle of the output shaft is sensed with a rotational angle sensor. The output shaft is supported by a housing and a cover. Reinforcing ribs are formed in a portion of the cover, which is made of resin and receives a reaction force generated by the operation of the actuator.

In a case of an engine that is provided with a supercharger, an output of the engine can be increased by increasing a port diameter of a bypass flow passage of the supercharger. However, when the port diameter is increased, a load, which is exerted by an exhaust gas pressure to the actuator through the boost pressure control valve, is disadvantageously increased. Therefore, it is required to increase the strength of the cover that serves as a support member, which supports the output shaft. The cover integrally holds an electric wiring of a sensing device of the rotational angle sensor and of an electric motor. Therefore, there is an extremely low degree of freedom in terms of selection of a material of the cover, and thereby there is a limit with respect to the improvement of the strength of the cover.

An actuator of the present disclosure includes an electric motor, an output shaft, a speed reducer, a rotational angle sensor, a housing and a wiring holder member. The speed reducer is configured to reduce a speed of rotation outputted from the electric motor and transmit the rotation of the reduced speed to the output shaft. The rotational angle sensor is configured to sense a rotational angle of the output shaft. The housing receives the electric motor and the speed reducer and supports the output shaft. The wiring holder member is a separate member formed separately from the housing while the wiring holder member integrally holds: a sensing device of the rotational angle sensor; and an electric wiring of the electric motor and of the sensing device.

The housing includes a connector insertion hole that extends through the housing from an inside to an outside of the housing. The wiring holder member forms a connector that receives an end portion of the electric wiring and projects from the inside to the outside of the housing through the connector insertion hole.

When the wiring holder member has the connector that projects to the outside of the housing through the connector insertion hole, the housing and the wiring holder member can be formed by separate members, respectively, and it is possible to select an optimal material for each of the housing and the wiring holder member. When the housing, which serves as the support member for supporting the output shaft, is formed by a material, such as metal or engineering plastic, which has the high strength, the strength of the housing can be guaranteed against a relatively large load exerted by the exhaust gas pulsation. Furthermore, when the wiring holder member is formed as a dielectric body, it is possible to hold the electric wiring while limiting a short circuit of the electric wiring. Further, when the electric wiring of the electric motor and of the sensing device is extended to the outside of the housing through the connector, the sealing between the wiring holder member and the housing can be made only at a single location.

Now, embodiments of the present disclosure will be described with reference to the accompanying drawings. In the following embodiments, similar portions, which are substantially identical to each other among the embodiments, will be indicated by the same reference signs and will not be described redundantly.

### First Embodiment

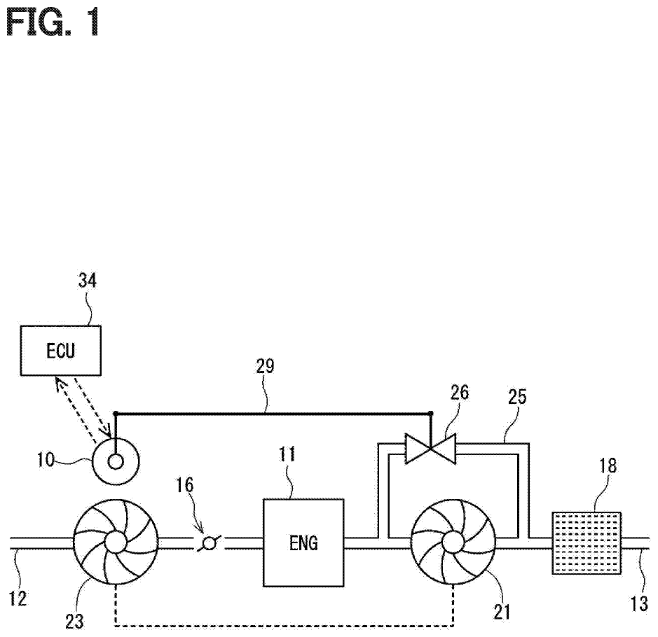

As shown in FIG. 1, an actuator 10 of the first embodiment is applied to an internal combustion engine 11 that is a drive source for driving a vehicle.

### (Intake and Exhaust System of Engine)

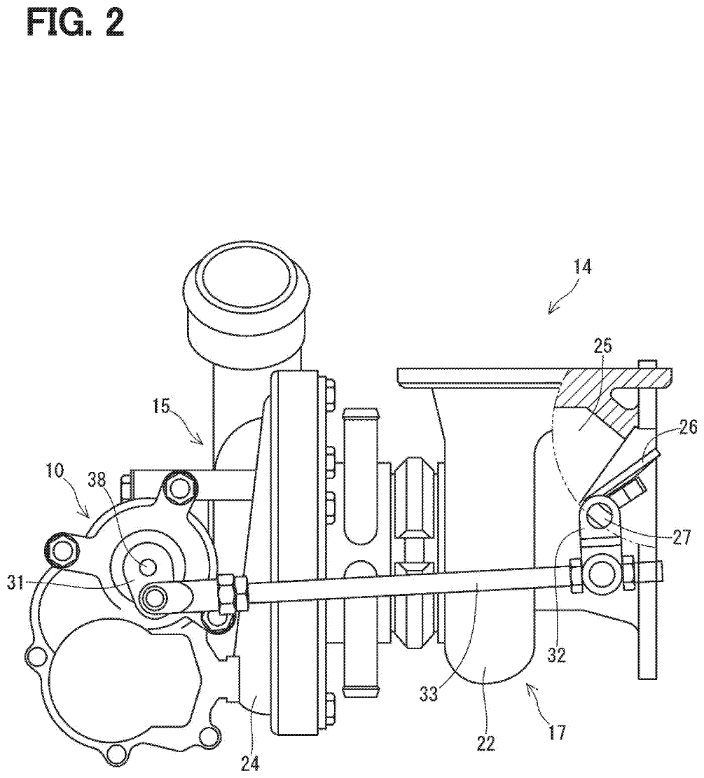

First of all, an intake and exhaust system of the engine 11 will be described with reference to FIGS. 1 and 2. The engine 11 has an intake passage 12, which conducts intake air to cylinders of the engine 11, and an exhaust passage 13, which discharges an exhaust gas generated at the cylinders to the atmosphere. An intake compressor 15 of a supercharger 14 and a throttle valve 16 are installed in the intake passage 12. The throttle valve 16 adjusts the amount of intake air supplied to the engine 11. An exhaust turbine 17 of the supercharger 14 and a catalyst 18 are installed in the exhaust passage 13. The catalyst 18 purifies the exhaust gas. The catalyst 18 is a known three-way catalyst, which has a monolithic structure. When the temperature of the catalyst 18 is raised to an activation temperature by the exhaust gas, the catalyst 18 purifies harmful substances contained in the exhaust gas through oxidation and reduction.

The exhaust turbine 17 includes a turbine wheel 21, which is rotated by the exhaust gas outputted from the engine 11, and a turbine housing 22, which is shaped in a spiral form and receives the turbine wheel 21. The intake compressor 15 includes a compressor wheel 23, which is rotated by a rotational force of the turbine wheel 21, and a compressor housing 24, which is shaped in a spiral form and receives the compressor wheel 23.

A bypass passage 25 is formed at the turbine housing 22. The bypass passage 25 conducts the exhaust gas while bypassing the turbine wheel 21. The bypass passage 25 directly conducts the exhaust gas, which enters the turbine housing 22, to an exhaust gas outlet of the turbine housing 22. The bypass passage 25 can be opened and closed by a wastegate valve 26. The wastegate valve 26 is a swing valve that is rotatably supported by a valve shaft 27 at the inside of the turbine housing 22.

The supercharger 14 includes the actuator 10 as a drive means for driving the wastegate valve 26. The actuator 10 is installed to the intake compressor 15 that is spaced away from the exhaust turbine 17 to avoid influences of the heat of the exhaust gas. The supercharger 14 includes a linkage mechanism 29 that transmits the output of the actuator 10 to the wastegate valve 26. The linkage mechanism 29 is a so-called four-bar linkage. The linkage mechanism 29 includes: an actuator lever 31, which is rotated by the actuator 10; a valve lever 32, which is coupled to the valve shaft 27; and a rod 33, which transmits a rotational torque from the actuator lever 31 to the valve lever 32.

The operation of the actuator 10 is controlled by an ECU (Engine Control Unit) 34 that has a microcomputer. Specifically, the ECU 34 controls a boost pressure of the supercharger 14 by adjusting an opening degree of the wastegate valve 26 at, for example, a high rotational speed of the engine 11. Furthermore, when the temperature of the catalyst 18 does not reach the activation temperature thereof at, for example, the time immediately after cold start of the engine 11, the ECU 34 fully opens the wastegate valve 26 to warm up the catalyst 18 with the exhaust gas. In this way, the high temperature exhaust gas, which has not lost its heat to the turbine wheel 21, can be conducted to the catalyst 18, so that the catalyst 18 can be warmed up within a short period of time.

### (Actuator)

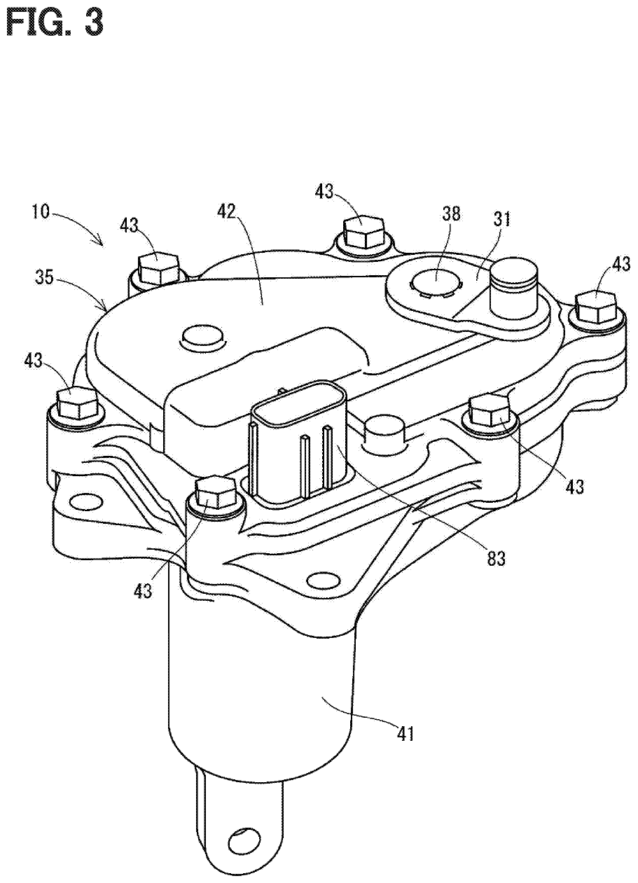

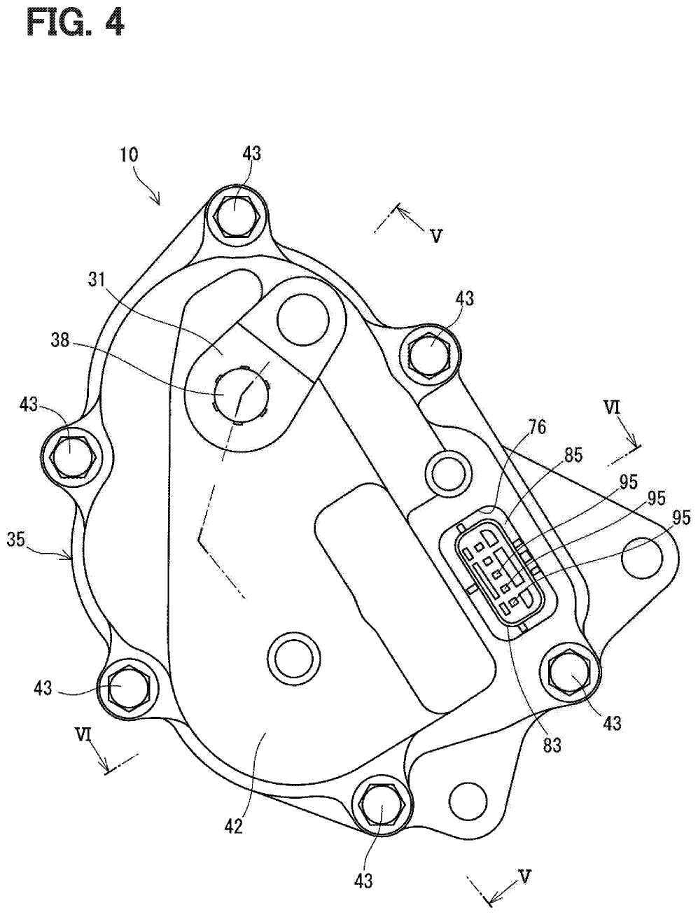

Next, the actuator 10 will be described with reference to FIGS. 3 to 7. The actuator 10 includes a housing 35, an electric motor 36, a speed reducer 37, an output shaft 38 and a rotational angle sensor 39. The housing 35 is installed to the intake compressor 15, and the electric motor 36, the speed reducer 37, the output shaft 38 and the rotational angle sensor 39 are installed in the housing 35.

As shown in FIGS. 3 to 5, the housing 35 includes a first housing segment 41 and a second housing segment 42. The second housing segment 42 is joined to the first housing segment 41 by fastening members 43. The first housing segment 41 and the second housing segment 42 cooperate together to form a receiving space 44 therein.

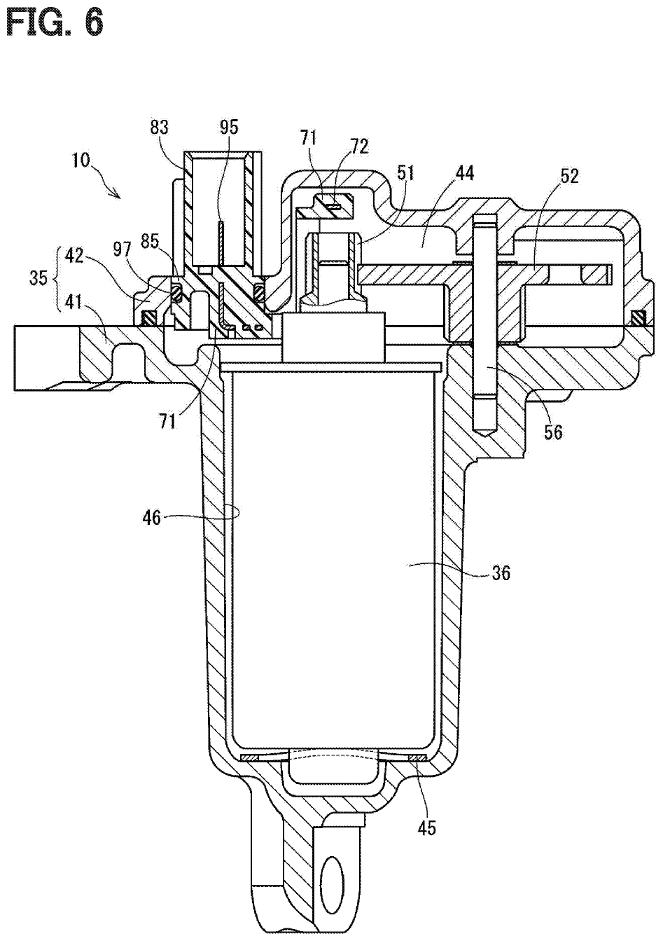

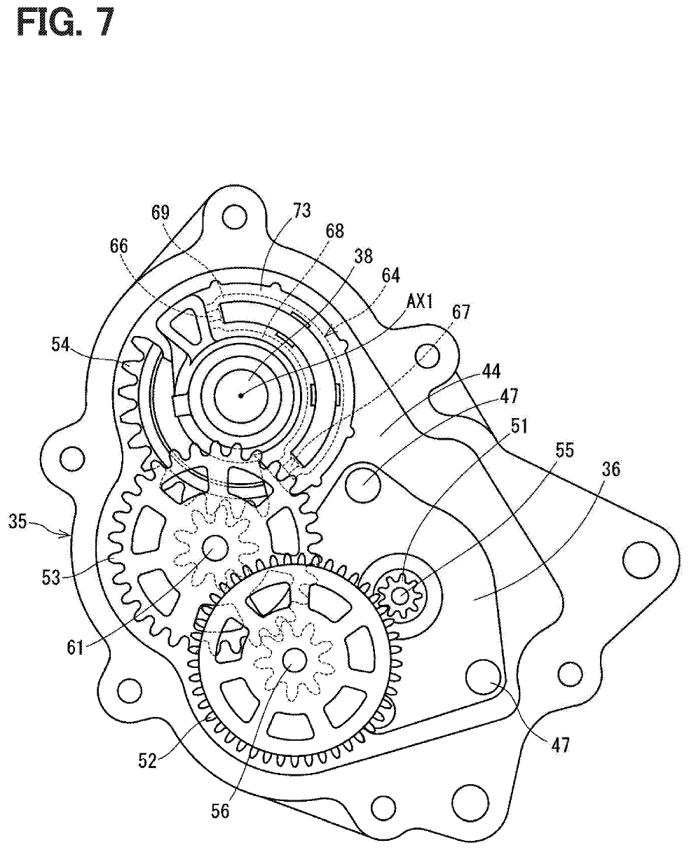

As shown in FIGS. 6 and 7, the electric motor 36 is received in the housing 35. Specifically, the electric motor 36 is inserted into a motor insertion hole 46 formed at the first housing segment 41 and is fixed to the first housing segment 41 by screws 47. A wave washer 45 is installed between the electric motor 36 and a bottom surface of the motor insertion hole 46. The electric motor 36 may be any type of electric motor, such as a known DC motor, a known stepping motor or the like.

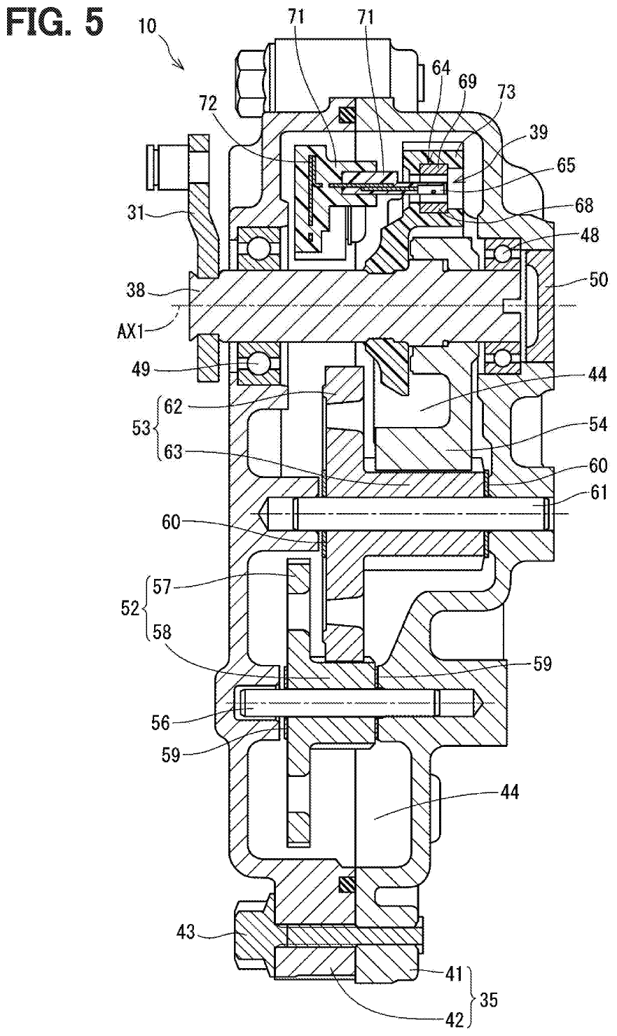

As shown in FIG. 5, the output shaft 38 is rotatably supported by a bearing 48, which is installed to the first housing segment 41, and a bearing 49, which is installed to the second housing segment 42. One end portion of the output shaft 38 outwardly projects from the housing 35. The actuator lever 31 is fixed to the output shaft 38 at the outside of the housing 35. A plug 50 is press fitted to a portion of the first housing segment 41, which is located at the other end side of the output shaft 38 along an imaginary extension line of the output shaft 38.

As shown in FIGS. 5 to 7, the speed reducer 37 is a parallel shaft speed reducer that reduces the speed of the rotation outputted from the electric motor 36 and transmits the rotation of the reduced speed to the output shaft 38. The speed reducer 37 includes a pinion gear 51, a first intermediate gear 52, a second intermediate gear 53 and a final gear 54. The pinion gear 51 is fixed to a motor shaft 55 of the electric motor 36. The first intermediate gear 52 is rotatably supported by a first metal shaft 56 and includes: a first large diameter external gear 57, which is meshed with the pinion gear 51; and a first small diameter external gear 58 that has a diameter smaller than a diameter of the first large diameter external gear 57. Two primary washers 59 are respectively installed to a location between the first intermediate gear 52 and the first housing segment 41 and a location between the first intermediate gear 52 and the second housing segment 42. The second intermediate gear 53 is rotatably supported by a second metal shaft 61 and includes: a second large diameter external gear 62, which is meshed with the first small diameter external gear 58; and a second small diameter external gear 63 that has a diameter smaller than a diameter of the second large diameter external gear 62. Two secondary washers 60 are respectively installed to a location between the second intermediate gear 53 and the first housing segment 41 and a location between the second intermediate gear 53 and the second housing segment 42. The final gear 54 is fixed to the output shaft 38 and is meshed with the second small diameter external gear 63.

As shown in FIGS. 5 and 7, the rotational angle sensor 39 is a contactless sensor that senses a rotational angle of the output shaft 38, and the rotational angle sensor 39 includes a magnetic circuit device 64 and a sensing device 65. The magnetic circuit device 64 includes magnets (serving as magnetic flux generators) 66, 67 and yokes (serving as magnetic flux conductors) 68, 69. The magnets 66, 67 and the yokes 68, 69 form a closed magnetic circuit that is shaped in an arcuate form in a view taken in an axial direction of the output shaft 38. The magnetic circuit device 64 is held by a magnetic circuit holder member 73 made of a non-magnetic material and is rotated integrally with the output shaft 38. The sensing device 65 is, for example, a Hall IC and is placed at an inside of the closed magnetic circuit of the magnetic circuit device 64. The sensing device 65 is fixed to the housing 35. The basic applications and functions of the magnetic circuit device 64 and the sensing device 65 are the same as those disclosed in JP2014-126548A (corresponding to US2014/0184204A, the disclosure of which is incorporated herein by reference in its entirety). The rotational angle of the output shaft 38, which is sensed with the rotational angle sensor 39, is outputted to the ECU 34 (see FIG. 1).

### (Housing and Peripheral Members Thereof)

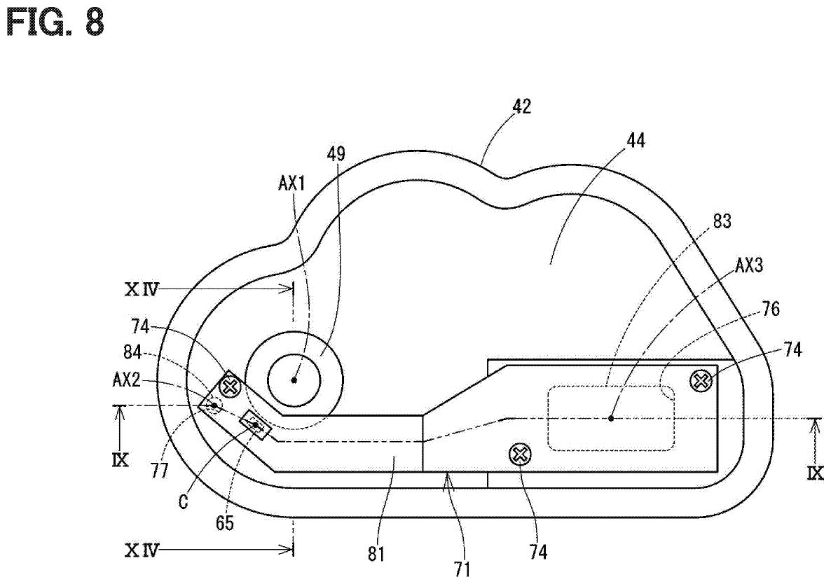

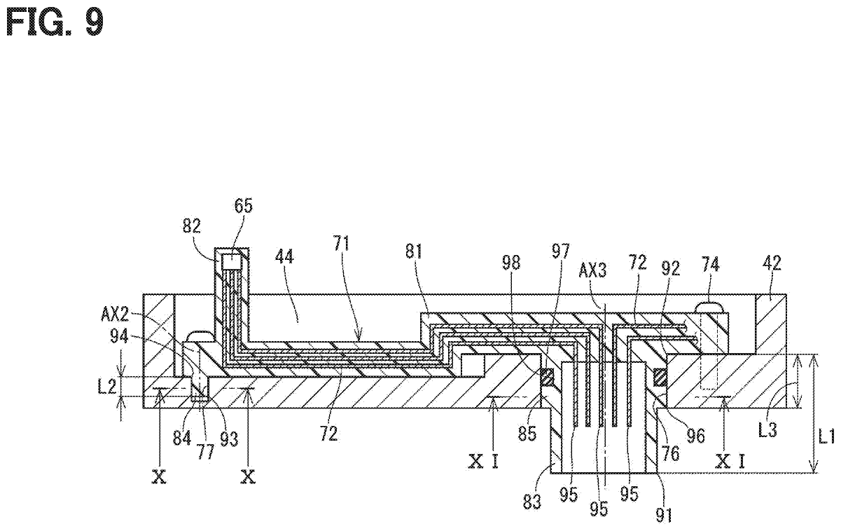

Next, the housing 35 and peripheral members thereof will be described. As shown in FIGS. 8 and 9, the actuator 10 includes the wiring holder member 71. The wiring holder member 71 integrally holds: the sensing device 65; and an electric wiring 72 of the electric motor 36 and of the sensing device 65. The magnetic circuit holder member 71 is a separate member that is formed separately from the housing 35, and a material of the wiring holder member 71 is different from a material of the housing 35. The first housing segment 41 and the second housing segment 42 are made of a metal material, such as an aluminum alloy. In contrast, the wiring holder member 71 is a dielectric body and is made of resin. The wiring holder member 71 forms an insert-molded product, in which the wiring holder member 71, the sensing device 65 and the electric wiring 72 are integrated together in one piece. The wiring holder member 71 is fixed to the second housing segment 42 by screws (serving as fastening members) 74.

The second housing segment 42 includes a connector insertion hole 76 and a positioning hole 77. The connector insertion hole 76 extends through the second housing segment 42 from an inside to an outside of the housing 35, and the positioning hole 77 is formed at an inner wall of the second housing segment 42. The wiring holder member 71 includes: a main body 81 that is formed to extend along the inner wall of the second housing segment 42; a sensor holder 82 that projects from the main body 81; a connector 83; and a positioning projection 84. The sensor holder 82 projects toward the first housing segment 41 and holds the sensing device 65.

The positioning projection 84 is fitted into the positioning hole 77. As shown in FIG. 10, a cross-section of the positioning projection 84, which is perpendicular to an inserting direction of the positioning projection 84 into the positioning hole 77, is shaped in a circular form. The inserting direction of the positioning projection 84 into the positioning hole 77 is a direction that is parallel to an axis of a center AX2 of the positioning projection 84. In FIG. 10, in order to ease understanding of the structure, a size of a gap between the positioning projection 84 and the positioning hole 77 is enlarged in comparison to an actual size of the gap.

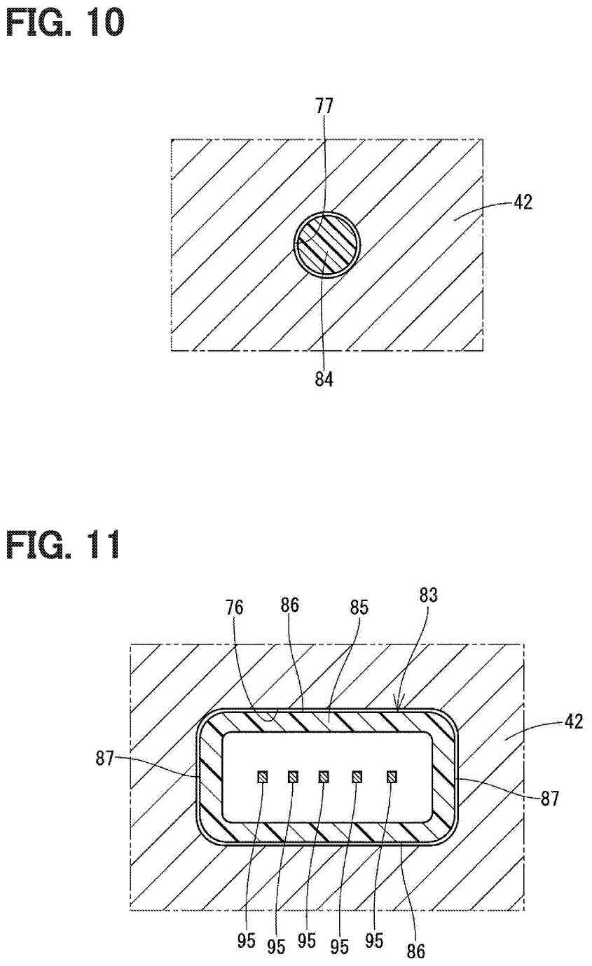

The connector 83 projects from the inside to the outside of the housing 35 through the connector insertion hole 76. The connector 83 includes a fitting portion 85 that is fitted into the connector insertion hole 76. As shown in FIG. 11, a cross-section of the fitting portion 85, which is perpendicular to an inserting direction of the fitting portion 85 into the connector insertion hole 76, is shaped in a non-circular form. The inserting direction of the fitting portion 85 into the connector insertion hole 76 coincides with an elongating direction of the connector 83, i.e., a projecting direction of the connector 83. A distal end portion of the connector 83 is slightly smaller than the fitting portion 85, but a shape of a cross-section of the distal end portion of the connector 83 is basically the same as a shape of a cross-section of the fitting portion 85 of the connector 83. In FIG. 11, in order to ease understanding of the structure, a size of a gap between the fitting portion 85 and the connector insertion hole 76 is enlarged in comparison to an actual size of the gap.

In the first embodiment, the cross-section of the fitting portion 85 is shaped in a rectangular form, each corner of which is rounded. Specifically, the cross-section of the fitting portion 85 has the shape that includes: a pair of primary straight sides 86, which are parallel to each other; and a pair of secondary straight sides 87, which are parallel to each other and are perpendicular to the pair of primary straight sides 86.

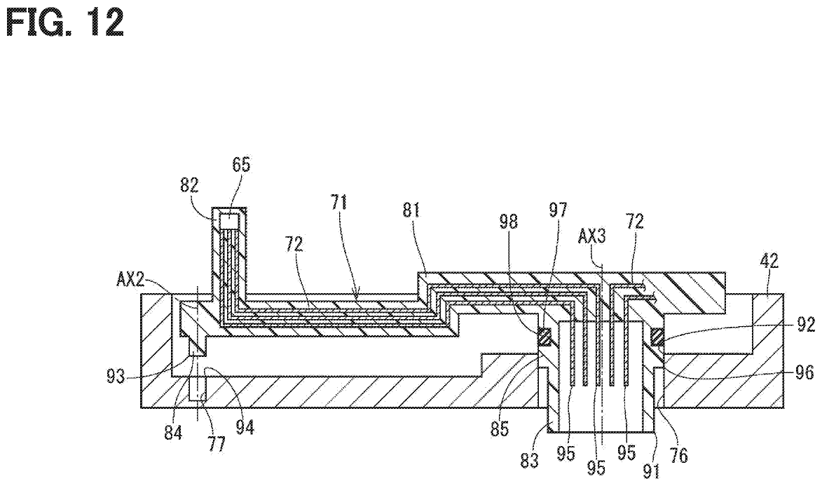

As shown in FIG. 9, the connector 83 and the positioning projection 84 are respectively inserted into the connector insertion hole 76 and the positioning hole 77 from one inside of the second housing segment 42. A distance L1, which is measured from an insertion distal end 91 of the connector 83 to an insertion inlet 92 of the connector insertion hole 76, is longer than a distance L2, which is measured from an insertion distal end 93 of the positioning projection 84 to an insertion inlet 94 of the positioning hole 77. In the first embodiment, a distance L3, which is measured from an insertion distal end 96 of the fitting portion 85 to the insertion inlet 92 of the connector insertion hole 76, is also longer than the distance L2. By satisfying these relationships, at the time of assembling the wiring holder member 71 to the second housing segment 42, as shown in FIG. 12, the distal end of the connector 83 is first fitted into the connector insertion hole 76 prior to reaching of the positioning projection 84 to the positioning hole 77, and thereafter the fitting portion 85 is fitted into the connector insertion hole 76.

As shown in FIGS. 8 and 9, once the wiring holder member 71 is assembled to the second housing segment 42, the screws 74 are inserted into the wiring holder member 71 and the second housing segment 42. An inserting direction of the respective screws 74 at this time coincides with an assembling direction of the wiring holder member 71 to the second housing segment 42. Specifically, the inserting direction of the fitting portion 85 into the connector insertion hole 76, the inserting direction of the positioning projection 84 into the positioning hole 77 and the inserting direction of the respective screws 74 into the wiring holder member 71 and the second housing segment 42 coincide with each other.

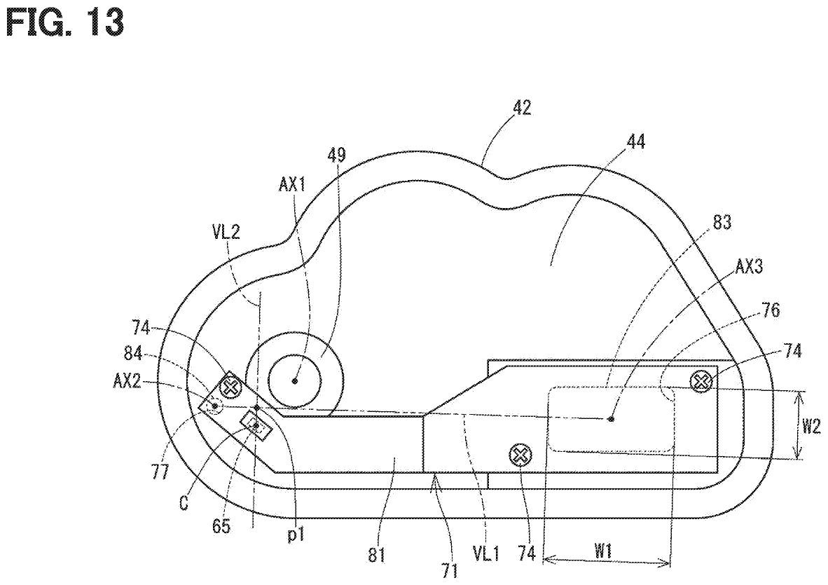

Now, a first imaginary straight line VL1 and a second imaginary straight line VL2 shown in FIG. 13 will be defined. In a view taken in the inserting direction of the fitting portion 85 into the connector insertion hole 76, the first imaginary straight line VL1 is an imaginary straight line, which connects between the center AX2 of the positioning projection 84 and a center AX3 of the fitting portion 85. Furthermore, the second imaginary straight line VL2 is an imaginary straight line that is perpendicular to the first imaginary straight line VL1 and passes through a center C of the sensing device 65. An intersection p1, at which the first imaginary straight line VL1 and the second imaginary straight line VL2 intersect with each other, is located between the center AX1 and the center AX2.

A width W1 of the fitting portion 85, which is measured in a direction along the first imaginary straight line VL1, is larger than a width W2 of the fitting portion 85, which is measured in a direction that is perpendicular to the first imaginary straight line VL1. In the first embodiment, connector terminals 95 are aligned in a longitudinal direction of the cross-section of the connector 83. An alignment direction of the connector terminals 95, in which the connector terminals 95 are aligned, and the direction along the first imaginary straight line VL1 substantially coincide with each other. The longitudinal direction of the cross-section of the connector 83 is directed toward the positioning projection 84.

As shown in FIG. 9, a seal member 97, which is shaped in a ring form, is installed in a gap, which is shaped in a ring form and is formed between an inner wall of the connector insertion hole 76 and the fitting portion 85 of the connector 83. The seal member 97 seals between the outside of the housing 35 and the receiving space 44. In the first embodiment, the groove 98, which is shaped in the ring form, is formed at the fitting portion 85. The seal member 97 is placed in the groove 98, which is shaped in the ring form, such that the seal member 97 extends all around the connector 83. Furthermore, the seal member 97 is clamped and is compressed between the inner wall of the connector insertion hole 76 and the connector 83. A compressing direction of the seal member 97 is a direction perpendicular to the inserting direction of the connector 83 and is a direction in which the inner wall of the connector insertion hole 76 and the connector 83 are opposed to each other.

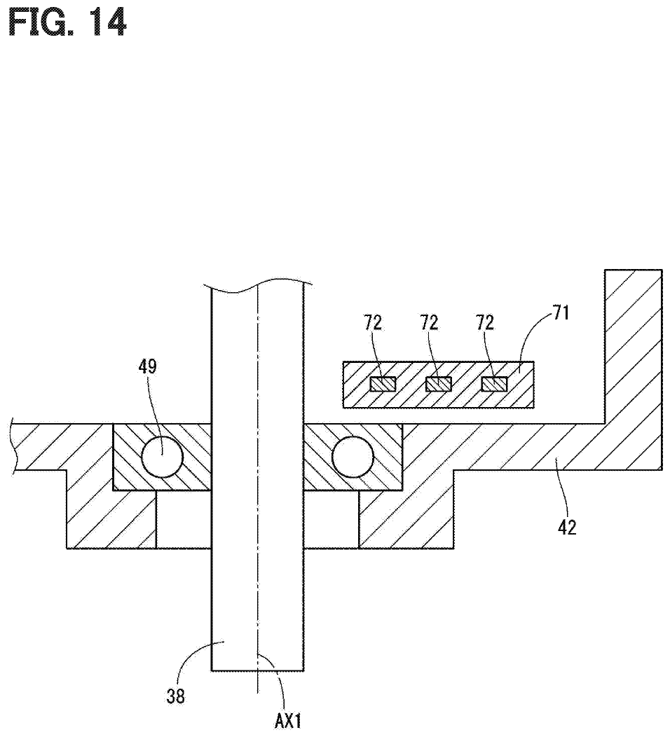

As shown in FIGS. 13 and 14, the wiring holder member 71 is placed such that the wiring holder member 71 overlaps with the bearing 49 (i.e., the bearing placed between the one end portion of the output shaft 38 and the second housing segment 42) in the view taken in the axial direction. Specifically, the wiring holder member 71 is placed such that the wiring holder member 71 and the bearing 49 make a three dimensional intersection.

### (Advantages)

As discussed above, the actuator 10 includes the electric motor 36, the output shaft 38, the speed reducer 37, the rotational angle sensor 39, the housing 35 and the wiring holder member 71. The wiring holder member 71 holds: the sensing device 65 of the rotational angle sensor 39; and the electric wiring 72 of the electric motor 36 and of the sensing device 65. The wiring holder member 71 is the separate member that is formed separately from the housing 35. The second housing segment 42 of the housing 35 includes the connector insertion hole 76 that extends through the second housing segment 42 from the inside to the outside of the housing 35. The wiring holder member 71 forms the connector 83 that receives the end portion of the electric wiring 72 and projects from the inside to the outside of the housing 35 through the connector insertion hole 76.

When the connector 83, which projects to the outside of the housing 35 through the connector insertion hole 76, is formed at the wiring holder member 71 as discussed above, the housing 35 and the wiring holder member 71 can be formed by the separate members, respectively, and it is possible to select an optimal material for each of the housing 35 and the wiring holder member 71. When the second housing segment 42, which serves as the support member for supporting the output shaft 38, is formed by the material, such as the aluminum alloy, which has the high strength, the strength of the second housing segment 42 can be guaranteed against the relatively large load exerted by the exhaust gas pulsation. Furthermore, when the wiring holder member 71 is formed as the dielectric body, it is possible to hold the electric wiring 72 while limiting the short circuit of the electric wiring 72. Further, when the electric wiring 72 of the electric motor 36 and of the sensing device 65 is extended to the outside of the housing 35 through the connector 83, the sealing between the wiring holder member 71 and the housing 35 can be made only at the single location.

Furthermore, in the first embodiment, the connector 83 includes the fitting portion 85 that is fitted into the connector insertion hole 76. The housing 35 includes the positioning hole 77, and the wiring holder member 71 includes the positioning projection 84 that is fitted into the positioning hole 77. The fitting portion 85 and the positioning projection 84 are formed in the above-described manner, so that the variations in the assembling position of the sensing device 65 can be limited. Thereby, the rotational angle sensing accuracy of the sensing device 65, which is installed to the magnetic circuit holder member 73, can be improved.

Furthermore, in the first embodiment, the intersection p1, at which the first imaginary straight line VL1 and the second imaginary straight line VL2 intersect with each other, is located between the center AX2 of the positioning projection 84 and the center AX3 of the fitting portion 85. In a case where the relative position of the wiring holder member 71 relative to the second housing segment 42 varies, the amount of variation is smaller when the sensing device 65 is placed within the range between the center AX2 of the positioning projection 84 and the center AX3 of the fitting portion 85 in comparison to the case where the sensing device 65 is placed at the outside of the range between the center AX2 of the positioning projection 84 and the center AX3 of the fitting portion 85. Therefore, when the sensing device 65 is placed within the above-described range, the rotational angle sensing accuracy of the sensing device 65 can be improved.

Furthermore, in the first embodiment, the cross-section of the positioning projection 84, which is perpendicular to the inserting direction of the positioning projection 84 into the positioning hole 77, is shaped in the circular form. The cross-section of the connector 83, which is perpendicular to the inserting direction of the connector 83 into the connector insertion hole 76, is shaped in the non-circular form. Furthermore, the distance L1 and the distance L3 are longer than the distance L2. Thus, at the time of assembling the wiring holder member 71 to the second housing segment 42, initially, the distal end of the connector 83 is fitted into the connector insertion hole 76, and then the fitting portion 85 is fitted into the connector insertion hole 76, and finally the positioning projection 84 is fitted into the positioning hole 77. Therefore, the angle of the wiring holder member 71 relative to the second housing segment 42 is limited by roughly fitting the distal end of the connector 83 into the connector insertion hole 76, and thereby the assembling positional relationship between the second housing segment 42 and the wiring holder member 71 can be roughly set. As a result, the positioning projection 84 can be smoothly fitted into the positioning hole 77.

Furthermore, in the first embodiment, the cross-section of the fitting portion 85, which is perpendicular to the inserting direction of the fitting portion 85 into the connector insertion hole 76, has the shape that includes: the pair of primary straight sides 86, which are parallel to each other; and the pair of secondary straight sides 87, which are parallel to each other and are perpendicular to the pair of primary straight sides 86. In this way, the shape of the fitting portion 85 is simplified, and the dimensional accuracy is improved. Thus, the positioning accuracy between the second housing segment 42 and the wiring holder member 71 can be improved.

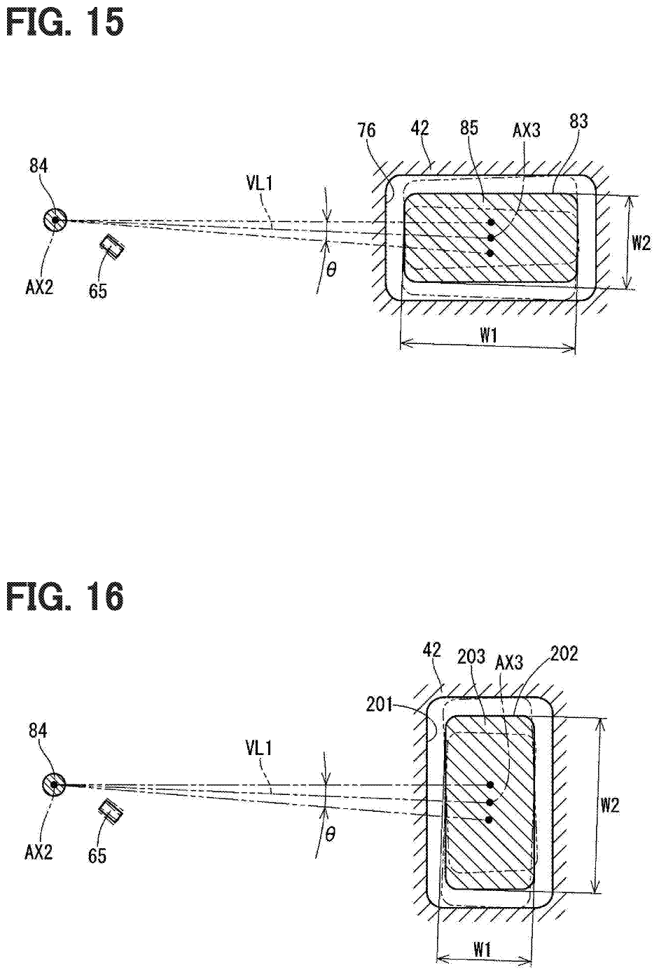

Furthermore, in the first embodiment, in the view taken in the inserting direction of the fitting portion 85 into the connector insertion hole 76, the width W1 of the fitting portion 85, which is measured in the direction along the first imaginary straight line VL1, is larger than the width W2 of the fitting portion 85, which is measured in the direction that is perpendicular to the first imaginary straight line VL1. With this setting, the fitting portion 85 is positioned at the location that is further spaced from the positioning projection 84. Therefore, when the fitting portion 85 limits the rotation of the wiring holder member 71 about the positioning projection 84, the angular variation relative to the dimensional variation can be made small. That is, in the case of the present embodiment where the width W1 is larger than the width W2 as schematically shown in FIG. 15, a rotation limit angle 8 is reduced in comparison to a comparative example where the width W1 of the fitting portion 203 of the connector 202, which is fitted into the connector insertion hole 201, is equal to or smaller than the width W2 of the fitting portion 203 of the connector 202 as schematically shown in FIG. 16. Therefore, the positioning accuracy between the second housing segment 42 and the wiring holder member 71 can be improved. In FIGS. 15 and 16, in order to ease understanding of the structure, the size of the gap between the fitting portion and the connector insertion hole is enlarged in comparison to the actual size of the gap.

Furthermore, in the first embodiment, the inserting direction of the fitting portion 85 into the connector insertion hole 76, the inserting direction of the positioning projection 84 into the positioning hole 77 and the inserting direction of the respective screws 74 into the wiring holder member 71 and the second housing segment 42 coincide with each other. In this way, the assembling can be carried out in the single direction, and thereby the assemblability is improved.

Furthermore, in the first embodiment, the seal member 97, which is shaped in the ring form, is installed in the gap, which is shaped in the ring form and is formed between the inner wall of the connector insertion hole 76 and the fitting portion 85. The seal member 97 is clamped and is compressed between the inner wall of the connector insertion hole 76 and the fitting portion 85. The seal member 97 seals between the outside of the housing 35 and the receiving space 44 to ensure waterproof and dustproof of the receiving space 44. Thereby, the electric motor 36, the speed reducer 37 and the rotational angle sensor 39, which are received in the inside of the housing 35, are protected from the external environment, and thereby robustness can be improved. Furthermore, by placing the seal member 97 into the gap, which is shaped in the ring form and is located between the inner wall of the connector insertion hole 76 and the fitting portion 85, space saving is possible. Furthermore, the connector 83 is centered in the connector insertion hole 76 by the tightening force of the seal member 97, so that the positioning accuracy is improved.

Furthermore, in the first embodiment, the wiring holder member 71 is placed to overlap with the bearing 49 placed between the one end portion of the output shaft 38 and the housing 35. A degree of freedom in terms of the layout of the electric wiring 72 is increased by permitting the three-dimensional intersection between the wiring holder member 71 and the bearing 49, and thereby the space saving and the size reduction can be achieved.

### Second Embodiment

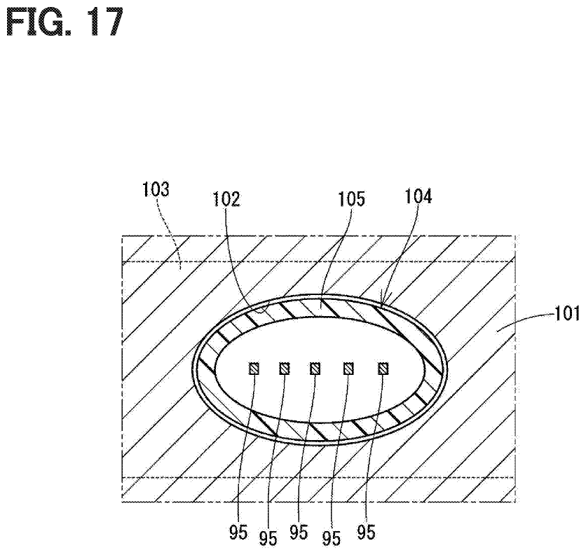

In a second embodiment, as shown in FIG. 17, a cross-section of the connector insertion hole 102 of the second housing segment 101 is shaped in an ellipse form, and a cross section of the fitting portion 105 of the connector 104 of the wiring holder member 103 is shaped in an ellipse form. As in this case, when the cross-section of the fitting portion 105 is in the non-circular form, the rotation of the wiring holder member 103 can be limited by the fitting portion 105.

### Third Embodiment

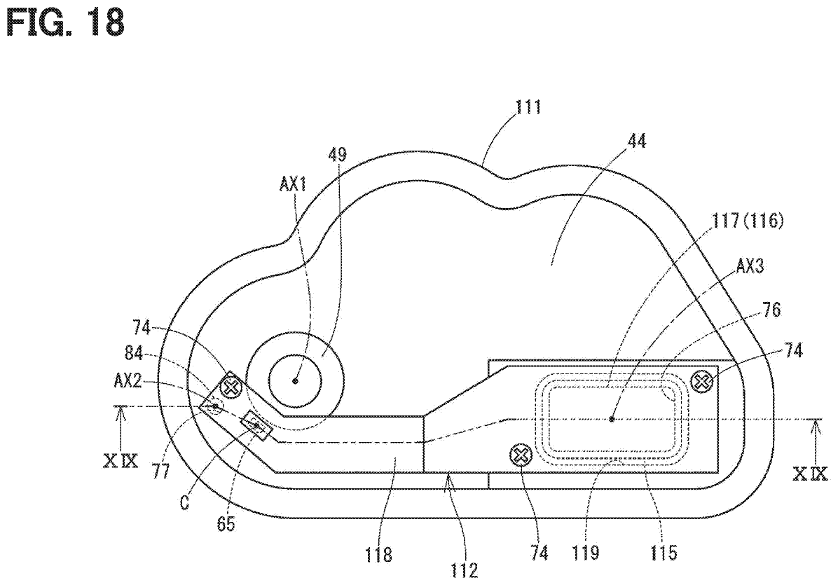

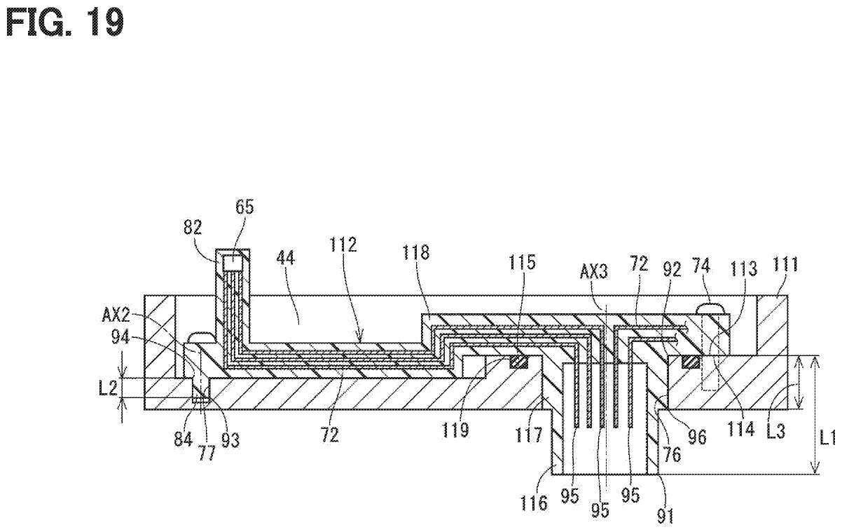

In a third embodiment, as shown in FIGS. 18 and 19, the seal member 115 is placed in the gap between two planar surfaces 113, 114 of the second housing segment 111 and of the wiring holder member 112. In the third embodiment, the groove, which is shaped in the ring form, is not formed at the fitting portion 117 of the connector 116 of the wiring holder member 112, and a groove 119, which is shaped in the ring form, is formed at the main body 118. The seal member 115 surrounds the connector 116 in the view taken in the inserting direction of the fitting portion 117 into the connector insertion hole 76. Furthermore, the seal member 115 is clamped and is compressed between the second housing segment 111 and the wiring holder member 112. A compressing direction of the seal member 115 coincides with the inserting direction of the connector 116 and is a direction in which the second housing segment 111 and the wiring holder member 112 are opposed to each other. As described above, the seal between the second housing segment and the wiring holder member may be a face seal.

### Other Embodiments

In another embodiment, the connector insertion hole may be formed at the first housing segment. Then, the wiring holder member may be fixed to the first housing segment. Furthermore, the material of the second housing segment should not be limited to the aluminum alloy. For example, the second housing segment may be made of a material, such as other type of metal (e.g., a magnesium alloy) or engineering plastic, which has the high strength. Even in such a case, the required strength of the second housing segment against the relatively large load caused by the pulsation of the exhaust gas can be ensured.

In another embodiment, the shape of the cross-section of the connector and the shape of the cross-section of the connector insertion hole should not be limited to the rectangular form or the ellipse form and may be changed to another non-circular form. Specifically, the shape can be any shape that can limit rotation of the connector relative to the connector insertion hole. Furthermore, the cross-section of the connector may be substantially constant along the length of the connector from the base portion (i.e., the fitting portion) to the distal end portion of the connector.

In another embodiment, the positioning projection may be formed at the housing, and the positioning hole may be formed at the wiring holder member. Furthermore, the way of fixing the wiring holder member to the housing should not be limited to the screws, and the wiring holder member may be fixed to the housing by another method, such as swaging or rivets. The groove, which is shaped in the ring form and receives the seal member (the seal that seals between the second housing segment and the wiring holder member) may be formed at any one of the housing and the wiring holder member.

The present disclosure has been described based on the embodiments. However, the present disclosure should not be limited to the above embodiments and the structure described therein. The present disclosure encompasses various modifications and equivalents. Also, various combinations and forms, as well as other combinations and forms including only one element, more or less, are within the scope and spirit of the present disclosure.

What is claimed is:

1. An actuator configured to drive a boost pressure control valve of a supercharger, the actuator comprising:
an electric motor;
an output shaft;
a speed reducer that is configured to reduce a speed of rotation outputted from the electric motor and transmit the rotation of the reduced speed to the output shaft;
a rotational angle sensor that is configured to sense a rotational angle of the output shaft;
a housing that receives the electric motor and the speed reducer and supports the output shaft; and
a wiring holder member that is a separate member formed separately from the housing while the wiring holder member integrally holds:
a sensing device of the rotational angle sensor; and
an electric wiring of the electric motor and of the sensing device, wherein:
the housing includes a first housing segment and a second housing segment while the second housing segment is a separate member formed separately from the first housing segment;
only one of the first housing segment and the second housing segment includes a connector insertion hole that extends through the housing from an inside to an outside of the housing; and
the wiring holder member forms a connector that receives an end portion of the electric wiring and projects from the inside to the outside of the housing through the connector insertion hole.

2. The actuator according to claim 1, wherein:
the connector includes a fitting portion that is fitted into the connector insertion hole;
one of the housing and the wiring holder member includes a positioning hole; and
the other one of the housing and the wiring holder member has a positioning projection that is fitted into the positioning hole.

3. The actuator according to claim 2, wherein:
in a view taken in an inserting direction of the fitting portion into the connector insertion hole, an imaginary straight line, which connects between a center of the positioning projection and a center of the fitting portion, is defined as a first imaginary straight line, and an imaginary straight line, which is perpendicular to the first imaginary straight line and passes through a center of the sensing device, is defined as a second imaginary straight line; and
an intersection, at which the first imaginary straight line and the second imaginary straight line intersect with each other, is located between the center of the positioning projection and the center of the fitting portion.

4. The actuator according to claim 2, wherein:
a cross-section of the positioning projection, which is perpendicular to an inserting direction of the positioning projection into the positioning hole, is shaped in a circular form;
a cross-section of the connector, which is perpendicular to an inserting direction of the connector into the connector insertion hole, is shaped in a non-circular form; and
a distance, which is measured from an insertion distal end of the connector to an insertion inlet of the connector insertion hole, is longer than a distance, which is measured from an insertion distal end of the positioning projection to an insertion inlet of the positioning hole.

5. The actuator according to claim 4, wherein a cross-section of the fitting portion, which is perpendicular to an inserting direction of the fitting portion into the connector insertion hole, has a shape that includes:
a pair of primary straight sides, which are parallel to each other; and
a pair of secondary straight sides, which are parallel to each other and are perpendicular to the pair of primary straight sides.

6. The actuator according to claim 5, wherein:
in a view taken in the inserting direction of the fitting portion into the connector insertion hole, an imaginary straight line, which connects between a center of the positioning projection and a center of the fitting portion, is defined as a first imaginary straight line; and
a width of the fitting portion, which is measured in a direction along the first imaginary straight line, is larger than a width of the fitting portion, which is measured in a direction that is perpendicular to the first imaginary straight line.

7. The actuator according to claim 2, comprising a fastening member that fastens the wiring holder member to the housing, wherein an inserting direction of the fitting portion into the connector insertion hole, an inserting direction of the positioning projection into the positioning hole, and an inserting direction of the fastening member into the wiring holder member coincide with each other.

8. The actuator according to claim 1, comprising a seal member that is placed in a gap between two planar surfaces of the housing and of the wiring holder member to surround the connector in a view taken in an inserting direction of the fitting portion into the connector insertion hole, wherein the seal member is clamped and is compressed between the housing and the wiring holder member.

9. The actuator according to claim 1, comprising a seal member that is shaped in a ring form and is placed in a gap, which is shaped in a ring form and is located between an inner wall of the connector insertion hole and the fitting portion, wherein the seal member is clamped and is compressed between the inner wall of the connector insertion hole and the fitting portion.

10. The actuator according to claim 1, comprising a bearing that is placed between one end portion of the output shaft and the housing, wherein the wiring holder member overlaps with the bearing in a view taken in an axial direction.
